(19) United States
(12) Patent Application Publication
(10) Pub. No.: US 2019/0212470 A1
(43) Pub. Date: Jul. 11, 2019

(54) FLOOD PREDICTION SYSTEM, PREDICTION METHOD, AND PROGRAM RECORDING MEDIUM

(71) Applicant: Mitsubishi Electric Corporation, Chiyoda-ku (JP)

(72) Inventors: Tomoyuki KOYANAGI, Chiyoda-ku (JP); Toshihiko ARIOKA, Chiyoda-ku (JP); Ikuo ABE, Izumi-ku (JP)

(73) Assignee: Mitsubishi Electric Corporation, Chiyoda-ku (JP)

(21) Appl. No.: 16/308,850

(22) PCT Filed: Sep. 25, 2017
(86) PCT No.: PCT/JP2017/034431

§ 371 Date: Dec. 11, 2018

(30) Foreign Application Priority Data
Sep. 29, 2016 (JP) 2016-190508

(51) Int. Cl. G01W 1/10; G01C 13/00; G06F 16/909

(52) U.S. Cl. CPC G01W 1/10; G08B 21/10; G06F 16/909; G01C 13/004

(57) ABSTRACT

A flood prediction system for predicting a flood depth of a flood prediction location on land that will be flooded by waves includes a prediction formula generator to select, based on maximum wave heights of the waves at observation positions on water and a flood depth of each land-based area that will be flooded by the waves, at least one of the observation positions in order to predict the flood depth of the flood prediction location within a land-based area and to generate a prediction formula for predicting the flood depth of the flood prediction location, and a flood depth predictor to acquire, from a sensor, a maximum wave height measurement value of the observation position selected by the prediction formula generator and to predict the flood depth of the flood prediction location by using the prediction formula.

### TECHNICAL FIELD

The present disclosure relates to a flood prediction system, a prediction method, and a program that predict flooding on land that is caused by a tsunami.

### BACKGROUND ART

In order to minimize damage caused by a tsunami, it is desirable to predict, before the arrival of a tsunami, whether or not there will be flooding, and in a case in which there will be flooding, it is desirable to predict a tsunami danger level such as a depth of flooding. Patent Literature 1 discloses a flood prediction system that determines the tsunami danger level by comparing a wave height of a tsunami and an elevation on land. Also, Patent Literature 2 discloses a technique for obtaining a wave height of a tsunami based on a flow speed on a water surface observed by a radar device.

### CITATION LIST

### Patent Literature

Patent Literature 1: Unexamined Japanese Patent Application Kokai Publication No. 2014-182564

Patent Literature 2: Unexamined Japanese Patent Application Kokai Publication No. 2016-85206

### SUMMARY OF INVENTION

### Technical Problem

The depth of flooding on land by the tsunami is not the same as a height of the tsunami at sea. In particular, in a case where a location is far from a coastline or a location is of complex terrain, the difference between the depth of flooding and the height of the tsunami at sea is great. Therefore, the flood prediction system described in Patent Literature 1 cannot accurately predict the tsunami danger level.

An objective of the present disclosure is to solve these challenges by obtaining a flood prediction system, a prediction method, and a program that can more accurately predict a tsunami danger level.

### Solution to Problem

The flood prediction system according to the present disclosure is a flood prediction system for predicting flood depths of flood prediction locations on land that will be flooded by waves, and the flood prediction system includes:

a prediction formula generator to select, based on maximum wave heights of the waves at observation positions on water and a flood depth of each land-based area that will be flooded by the waves, at least one of the observation positions in order to predict a flood depth of a flood prediction location within a land-based area and to generate a prediction formula for predicting the flood depth of the flood prediction location; and

a flood depth predictor to acquire, from a sensor, a maximum wave height measurement value of the observation position selected by the prediction formula generator and to predict the flood depth of the flood prediction location by using the prediction formula.

### Advantageous Effects of Invention

According to the present disclosure, the flood prediction system that accurately obtains a depth of flooding on land that is caused by a tsunami can be obtained.

### BRIEF DESCRIPTION OF DRAWINGS

FIG. 1 is a diagram illustrating an example of a wave height acquisition position, an observation position, and a flood prediction location in Embodiment 1;

FIG. 2 is a diagram illustrating a configuration of a flood prediction system in Embodiment 1;

FIG. 3A is a graph illustrating a relationship between a maximum wave height at an observation location and a flood depth at a flood prediction location in Embodiment 1;

FIG. 3B is a graph illustrating a relationship between the flood depth at the flood prediction location and a severity of damage to be caused by flooding in Embodiment 1;

FIG. 4 is a block diagram illustrating an example of a hardware configuration of the flood prediction system in Embodiment 1;

FIG. 5 is a flowchart illustrating a processing flow of a flood depth predictor of the flood prediction system in Embodiment 1;

FIG. 6 is a diagram illustrating a configuration of a flood prediction system in Embodiment 2;

FIG. 7 is a flowchart illustrating a processing flow of a flood depth predictor of the flood prediction system in Embodiment 2;

FIG. 8 is a diagram illustrating a configuration of a flood prediction system in Embodiment 3;

FIG. 9 is a flowchart illustrating a processing flow of a flood depth predictor of the flood prediction system in Embodiment 3;

FIG. 10 is a diagram illustrating a configuration of a flood prediction system in Embodiment 4; and

FIG. 11 is a flowchart illustrating a processing flow of a flood depth predictor of the flood prediction system in Embodiment 4.

### DESCRIPTION OF EMBODIMENTS

### Embodiment 1

A flood prediction system 100 according to this embodiment of the present disclosure and a prediction method executed by the flood prediction system 100 are described next.

The flood prediction system 100 according to the present embodiment is a device that observes a maximum wave height of a tsunami at multiple positions (hereinafter referred to as an observation position) at sea and forecasts a flood depth of any location (hereinafter referred to as flood prediction location) on a land surface based on the observed maximum wave height.

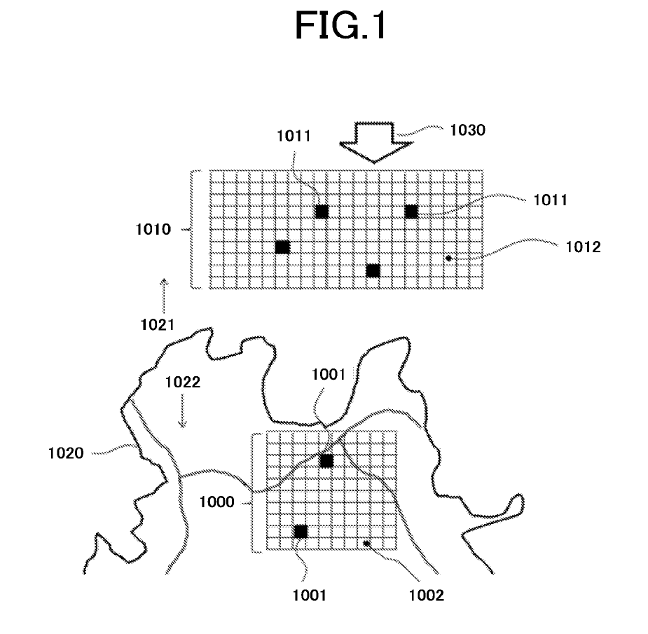

First, the observation position and the flood prediction location are described with reference to FIG. 1. FIG. 1 illustrates a sea and land combination-based example. In FIG. 1, a coastline 1020 divides a map into an upper portion that is a sea 1021 and a lower portion that is land 1022. As illustrated by an arrow 1030, a tsunami is approaching the land from the sea.

The flood prediction system 100 recognizes the land 1022 as a collection 1000 divided into a mesh of land-based areas 1001 each having the same width. Further, within any of the land-based areas 1001, the flood prediction system 100 regards any important location having, for example, a house or building as a flood prediction location 1002 for which a prediction is made as to whether or not flooding will occur. The flood prediction system 100 predicts whether or not each flood prediction location 1002 will be flooded by the tsunami, and in the case where there will be flooding, obtains a flood depth that is the height from the ground to the water surface where there will be flooding.

Further, the flood prediction system 100 recognizes the sea 1021 as a collection 1010 divided into a mesh of areas 1011 each having the same width. Hereinafter, among the areas 1011 on the sea, the areas 1011 where a height of wave is measured is referred to as an observation position 1012.

The flood prediction system 100 uses a maximum wave height among the wave heights at each observation position 1012 in order to make a prediction. The maximum wave height is a maximum value of wave heights at each observation position 1012. When measuring for a maximum wave height, a maximum value among wave heights observed during the past N-hour(s) at each observation position 1012 is measured. Here, the uppercase letter “N” refers to, for example, a period of one to three hours. Examples of sensors that measure wave heights include pressure meters disposed on the sea floor, GPS buoys, and radar, and any of these examples may be used. Also, the type of data acquired by the sensor that may be used is not limited to a type of data acquired by the sensor by directly measuring the wave height. A type of data in which the flow speed of the water surface is measured and the wave height is indirectly calculated based on the measured flow speed may be used for example.

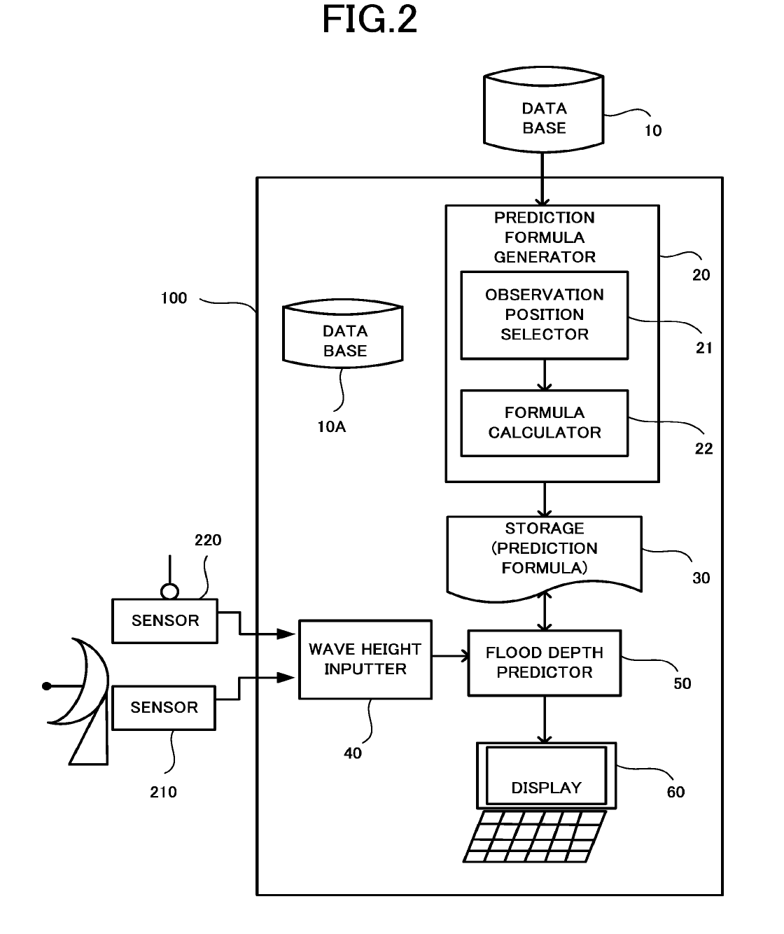

The flood prediction system 100 according to Embodiment 1, as illustrated in FIG. 2, includes a prediction formula generator 20, a storage 30, a wave height inputter 40, a flood depth predictor 50, and a display 60.

Further, the flood prediction system 100 is connected via a network to a database 10 located outside of the flood prediction system 100, and refers to the database 10. For multiple tsunamis in the past, the database 10 stores maximum wave heights at observations positions 1012 and observation values of flood depths at the land-based areas 1001 for each tsunami, and calculation values based on simulated calculations. The database 10 may store simulation-based values. The database 10 is described in detail further below.

The prediction formula generator 20 includes an observation position selector 21 and a formula calculator 22.

The observation position selector 21 selects at least one observation position 1012 in order to predict a flood depth of one predetermined flood prediction location 1002 or flood depths of multiple predetermined flood prediction locations 1002. The observation position selector 21 selects the observation position 1012 based on a maximum wave height of a wave at each of the observation positions 1012 on the sea and the flood depth at each of the land-based areas 1001 that flood, which are stored in the database 10. The selected observation position 1012 is hereinafter referred to as a wave height acquisition position 1011. In a case in which there are multiple flood prediction locations 1002, the observation position selector 21 selects a wave height acquisition position 1011 for each of the flood prediction locations 1002.

The formula calculator 22 generates a prediction formula for predicting a flood depth for each of the flood prediction locations 1002 based on the maximum wave height of the wave at each of the observation positions 1012 and the flood depths of the land-based areas 1001 that flooded, which are stored in the database 10.

The prediction formula generator 20 stores the wave height acquisition position 1011 selected by the observation position selector 21 and the prediction formula calculated by the formula calculator 22 into the storage 30.

The wave height inputter 40 acquires a measured value of a maximum wave height at an observation position 1012 from a sensor 210 and a sensor 220 that measures wave heights. Hereinafter, the maximum wave height at the observation position 1012 acquired by the wave height inputter 40 is referred to as the maximum wave height measurement value.

The flood depth predictor 50 predicts a flood depth for each of the flood prediction locations 1002 based on (i) a maximum wave height measurement value at the wave height acquisition position 1011 stored in storage 30 among the values of the maximum wave heights supplied from the wave height inputter 40 and (ii) the prediction formula stored in the storage 30.

The database 10, as illustrated in Table 1, has stored therein, for multiple tsunamis, a tsunami identification number k, an epicenter position (xₖ, yₖ, zₖ) of an earthquake that triggered a tsunami, a magnitude, maximum wave heights (H₁ₖ, H₂ₖ, H₃ₖ, H₄ₖ, . . . ) in observation positions 1012 (W1, W2, W3, W4, . . . ), and flood depths (D₁ₖ, D₂ₖ, D₃ₖ, D₄ₖ, . . . ) in multiple land-based areas 1001 (G1, G2, G3, G4, . . . ). The lowercase letter “k” is a natural number. Data regarding a tsunami measured from observation positions 1012 or the land-based area 1001 may be gathered as the data of the database 10. Also, in order to accumulate data of the observation positions 1012 and land-based areas 1001 for a greater number of tsunamis, data from simulations in which occurrence conditions of the earthquake such as the epicenter position and the magnitude are modified may be accumulated. Although Table 1 illustrates an example in which there are four observation positions 1012, the observation position 1012, may be of any number as long as the number is more than one. Likewise, the land-based areas 1001 may be of any number. It is unnecessary for the observation positions 1012 and the land-based areas 1001 to be the same in number. The number of the observation positions 1012 and the number of the land-based areas 1001 may be set independently of one another.

TABLE 1

| | | | Maximum wave height | | | | | | | |
|---|---|---|---|---|---|---|---|---|---|---|
| | Epicenter | | [m] | | | | Flood depth [m] | | | |
| No. | position | Magnitude | W1 | W2 | W3 | W4 | G1 | G2 | G3 | G4 |
| 1 | (x₁, y₁, z₁) | nn. m | H₁₁ | H₂₁ | H₃₁ | H₄₁ | D₁₁ | D₂₁ | D₃₁ | D₄₁ |
| 2 | (x₂, y₂, z₂) | nn. m | H₁₂ | H₂₂ | H₃₂ | H₄₂ | D₁₂ | D₂₂ | D₃₂ | D₄₂ |
| . . . | . . . | . . . | . . . | . . . | . . . | . . . | . . . | . . . | . . . | . . . |

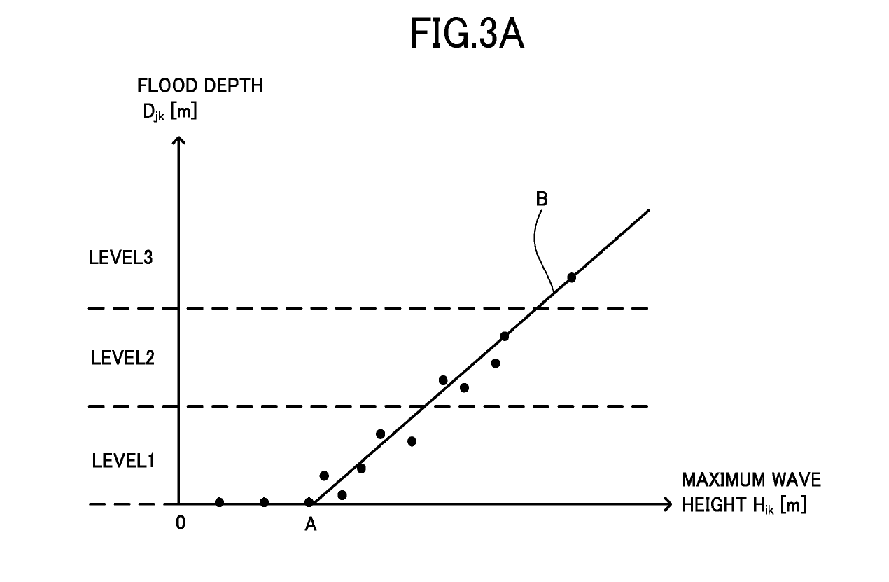

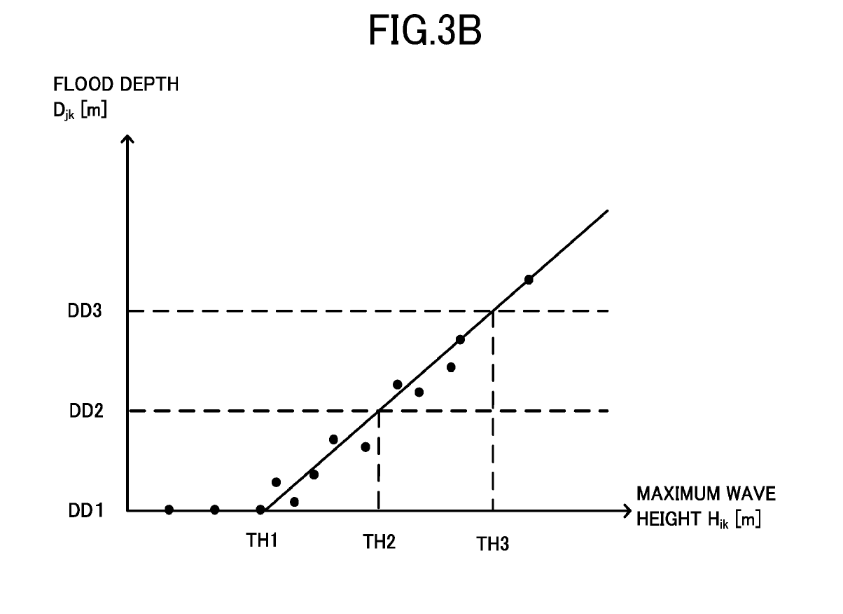

FIG. 3A is a graph illustrating the relationship between a maximum wave height in the observation position 1012 and a flood depth in one of the land-based areas 1001. The sets (Hᵢₖ, Dⱼₖ) in Table 1 of the maximum wave height Hᵢₖ (lowercase letter “k” refers to the tsunami identification number) in Wi (i=1, 2, . . . ), which is the observation position 1012, and the flood depth Dⱼₖ in Gj (j=1, 2, . . . ), which is one of the land-based areas 1001 are represented in the graph of FIG. 3A indicating multiple tsunamis. The individual data points in FIG. 3A denote (Hᵢₖ, Dⱼₖ) for each tsunami k. As illustrated in FIG. 3A, as the flood depth Dⱼₖ rises, the extent of the damage also changes in that, on land, flooding occurs, buildings get destroyed and swept away by the flood.

On land, when the scale of the tsunami increases and the maximum wave height Hᵢₖ of the tsunami is greater than or equal to the constant value “A”, flooding occurs. This constant value “A” is “0” at a position where the elevation at the shore is 0 [m] and this value progressively increases the further inland the target land-based areas 1001 are or the higher the elevation is of the land-based areas 1001. Therefore, regarding the relationship between the maximum wave height Hᵢₖ and the flood depth Dⱼₖ, when the maximum wave height Hᵢₖ is less than the constant value “A”, the flood depth Dⱼₖ is 0 [m], whereas when the maximum wave height Hᵢₖ is greater than or equal to the constant value “A”, the flood depth Dⱼₖ is a depth [m] that is proportional to the value remaining after subtraction of the constant value “A” from the maximum wave height Hᵢₖ. Also, in a distribution map indicating the relationship between the maximum wave height Hᵢₖ and the flood depth Dⱼₖ, the maximum wave height Hᵢₖ at the constant value “A” becomes a kinked bent line as illustrated in FIG. 3A.

The observation position selector 21 selects and recognizes at least one observation position 1012 as the wave height acquisition position 1011 in order to calculate a flood depth Dⱼₖ at the flood prediction location 1002. The observation position selector 21 selects the wave height acquisition position 1011 among the observation positions 1012, based on the mutual distribution between the flood depth Dⱼₖ at flood prediction location 1002 and the maximum wave height Hᵢₖ at each of the observation positions 1012 illustrated in FIG. 3A regarding the data of the tsunamis included in the database 10. The observation position selector 21 selects, as the wave height acquisition position 1011, an observation position 1012 with which the error of the prediction value of the flood depth Dⱼₖ is small when the maximum wave height Hᵢₖ is calculated based on the relationship of FIG. 3A. Specifically, the observation position selector 21 selects, from data of the tsunamis included in the database 10, the wave height acquisition position 1011 based on a correlation coefficient between the maximum wave height Hᵢₖ for the flood prediction location 1002 where flooding is to occur due to a tsunami and the flood depth Dⱼₖ at the flood prediction location 1002. Generally, the stronger the correlation coefficient of two variables is, the closer the correlation coefficient value is to 1. Therefore, the observation position selector 21 recognizes the correlation coefficient as, for example, 0.9 to 1.0. In this way, the observation position 1012 that is within a set predetermined range is the wave height acquisition position 1011.

In addition to the above, the observation position selector 21 may select an observation position 1012 in which the distance from the flood prediction location 1002 is within the predetermined range, as a wave height acquisition position 1011. For example, when flooding is forecasted, a predetermined range for a distance is determined, for example, by the time it takes for the measures to be taken against the flooding at the flood prediction location 1002. It is necessary for the flood prediction system 100 to predict flooding with just enough time left before the arrival of the tsunami. The wording “enough time” refers to an evacuation time Te that is the minimum time necessary to evacuate from the flood prediction location 1002 to an evacuation area, for example. The speed Vt of the tsunami near observation position 1012 can be obtained by the depth of the sea near the observation position 1012. From this, in order to make a forecast before the evacuation time Te prior to flooding, the observation position selector 21 may select the observation position 1012 in which the position is at a distance greater than or equal to Vt×Te from the flood prediction location 1002 as the wave height acquisition position 1011.

The formula calculator 22 generates a prediction formula to predict a flood depth Dⱼₖ at the flood prediction location 1002 from the maximum wave height Hᵢₖ at the wave height acquisition position 1011 based on data of tsunamis included in the database 10. The formula calculator 22 generates a prediction formula based the relationship indicated in FIG. 3A between the maximum wave height Hᵢₖ at the wave height acquisition position 1011 and the flood depth Dⱼₖ at the flood prediction location 1002 that are in the data of tsunamis included in the database 10. As can be seen from FIG. 3A, as the maximum wave height Hᵢₖ at the wave height acquisition position 1011 increases, the prediction value of the flood depth Dⱼₖ at the flood prediction location 1002 monotonically increases. Therefore the formula calculator 22 generates a prediction formula indicating the formula (1) below, based on the data of tsunamis included in the database 10, the flood prediction location 1002 will flood, that is, between the maximum wave height Hᵢₖ at the wave height acquisition position 1011 and the flood depth Dⱼₖ at the flood prediction location 1002 regarding a tsunami for which the flood depth Dⱼₖ exceeds 0 [m].

$$[ Formula 1 ]$$

$$Flood Depth ( D ) = \{ \begin{matrix}m \times ( Maximum wave height ( H ) - ( A ) ) & ( H > A ) \\ 0 & ( H \leq A )\end{matrix} \qquad ( 1 )$$

Here, the lowercase letter “m” refers to slope “m” of the linear regression line “B” in FIG. 3A. The uppercase letter “A” refers to the constant value “A” of the maximum wave height Hᵢₖ in aforementioned FIG. 3A, where the flood depth Dⱼₖ exceeds 0 [m]. Regarding tsunamis in which the flood depth Dⱼₖ at the flood prediction location 1002 exceeds 0 [m] or a predetermined constant value “ε”, the formula calculator 22 performs regression calculation on data of the maximum wave height Hᵢₖ at the wave height acquisition position 1011 and the flood depth Dⱼₖ at the flood prediction location 1002 to obtain the slope “m” and the constant value “A”. In the regression calculation, a calculation based on linear regression for example is used. The formula calculator 22 stores the generated prediction formula (1) of the flood depth Dⱼₖ in the storage 30. The predetermined constant value ε of the aforementioned flood depth Dⱼₖ is a value determined based on, for example, a measurement error of the flood depth Dⱼₖ included in the database 10 and is a positive value greater than or equal to “0”.

The wave height inputter 40 acquires the maximum wave height Hᵢₖ at each of the observation positions 1012 from one or more sensors (sensor 210 of the radar device and/or sensor 220 of the GPS wave height measurer) that each measure wave heights. For example, in the case in which sensors that are capable of acquiring a maximum wave height Hᵢₖ over a wide area such as the radar device are used as the sensors, the wave height inputter 40 acquires the maximum wave height Hᵢₖ at each of the observation positions 1012 from the data of the maximum wave height Hᵢₖ output by the sensors. In the case in which sensors that measure the wave height at a predetermined position such as the GPS wave height measurer are used as the sensors, the wave height inputter 40 acquires data of the maximum wave height Hᵢₖ from each of the sensors placed at each observation position 1012.

The flood depth predictor 50 refers to the storage 30 and acquires the stored wave height acquisition position 1011 and the prediction formula of the flood depth Dᵢₖ for each flood prediction position. In the case in which the formula (1) is stored in the storage 30 by the prediction formula generator 20, the flood depth predictor 50, the prediction formula generator 20 acquires the formula (1). The flood depth predictor 50 substitutes the value at the wave height acquisition position 1011, among the maximum wave height (maximum wave height measurement value) of each of the observation positions 1012 acquired by the wave height inputter 40, for the maximum wave height into the formula (1) and calculates the prediction value for the flood depth at the flood prediction location 1002. The display 60 displays the prediction value for the flood depth at the flood prediction location 1002 that is calculated by the flood depth predictor 50.

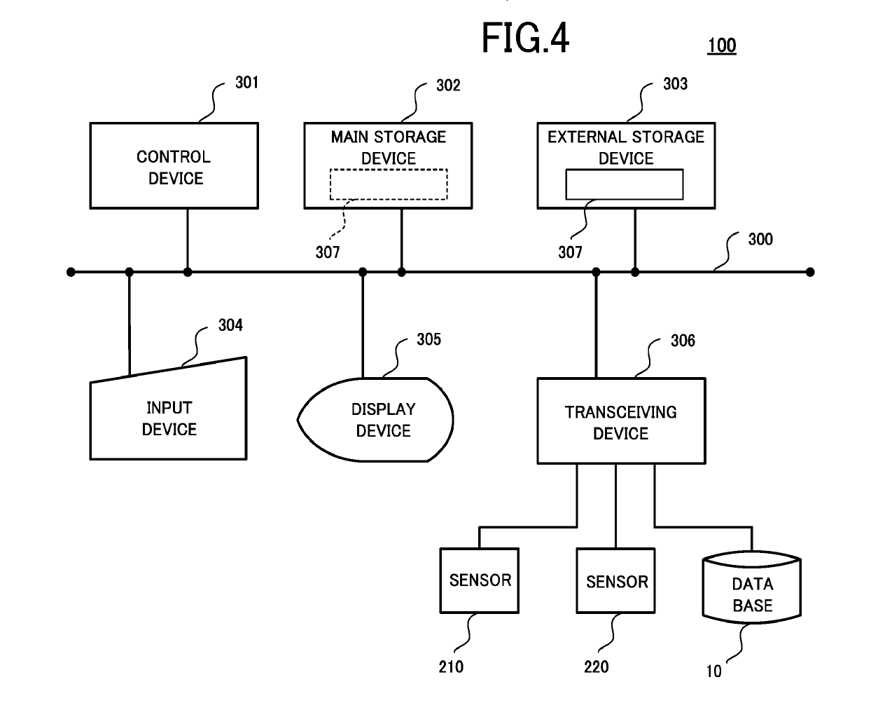

FIG. 4 is a block diagram illustrating an example of a hardware configuration of the flood prediction system 100. The flood prediction system 100 includes a control device 301, a main storage device 302, an external storage device 303, an input device 304, a display device 305, and a transceiving device 306. The main storage device 302, the external storage device 303, the input device 304, the display device 305, and the transceiving device 306 are connected to the control device 301 through an internal bus 300.

The control device 301 includes, for example, a central processing unit (CPU). The control device 301 executes, in accordance with a control program 307 stored in the external storage device 303, processing of the flood prediction system 100. Specifically, the control device 301 functions as the prediction formula generator 20, the wave height inputter 40, and the flood depth predictor 50 of the flood prediction system 100.

The main storage device 302 includes, for example, a random-access memory (RAM). The main storage device 302 loads the control program 307 stored in the external storage device 303 described in detail further below. The main storage device 302 is used as a working area of the control device 301.

The external storage device 303 includes a non-volatile memory, for example, such as a flash memory, a hard disk, a digital versatile disc random-access memory (DVD-RAM), and a digital versatile disc rewritable (DVD-RW). The control program 307 for causing the control device 301 to perform processing of the flood prediction system 100 is stored beforehand in the external storage device 303. Also, the external storage device 303 supplies data that is stored by the control program 307 to the control device 301 and stores data supplied by the control device 301. Specifically, the external storage device 303 functions as the storage 30 of the flood prediction system 100.

The input device 304 includes, for example, a keyboard, a pointing device such as mouse, and an interface device that connects the keyboard and pointing device with the internal bus 300. In a case in which the user performs the various settings, the input information is supplied to the control device 301 via the input device 304.

The display device 305 includes, for example, a cathode ray tube (CRT) or a liquid crystal display (LCD). When processing of the control program 307 is executed by the control device 301, the display device 305 displays, in accordance with the control of the control device 301, data measured by the sensors 210 and 220 and prediction values of flooding. Specifically, the display device 305 functions as the display 60 of the flood prediction system 100.

The transceiving device 306 includes an interface device that connects external apparatuses such as the sensors 210 and 220 and the database 10 with the internal bus 300. The data measured by the sensors 210 and 220 is provided to the control device 301 via the transceiving device 306. Also, the data of the tsunamis stored in the database 10 is also provided to the control device 301 via the transceiving device 306. Specifically, the transceiving device 306 functions as the wave height inputter 40 of the flood prediction system 100.

The hardware configuration illustrated in FIG. 4 is implementable using a general computer system instead of a dedicated system. For example, the prediction formula generator 20, the wave height inputter 40, the flood depth predictor 50, and the display 60 of the flood prediction system 100 illustrated in FIG. 2 may be realized by storing a computer program for executing the aforementioned operations on a computer-readable recording medium (such as a flexible disc, CD-ROM, DVD-ROM, and the like), by distributing the recording medium, and by installing the computer program stored in the recording medium on the computer. Further, a similar configuration may also be realized by storing beforehand the computer program on a memory device of a server device on a communication network such as the Internet, and by downloading the computer program by a normal computer system.

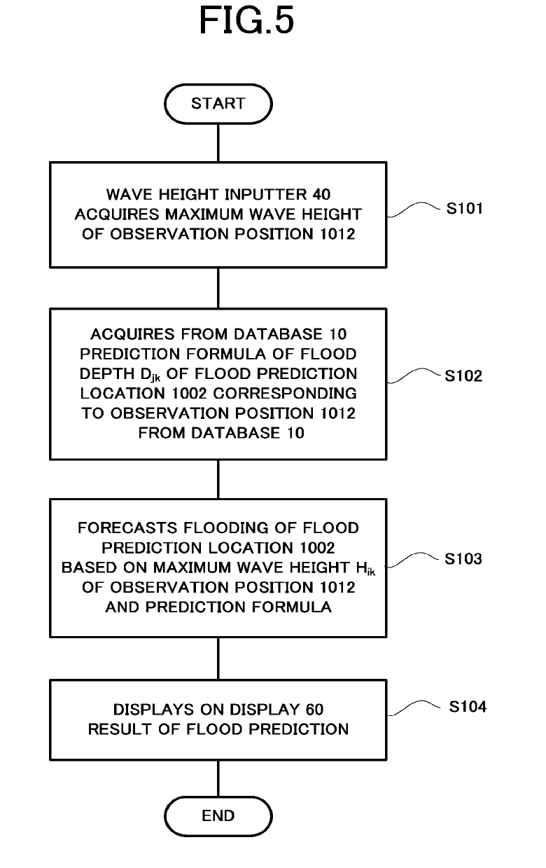

FIG. 5 is a flowchart illustrating a processing flow of the flood prediction system 100 in Embodiment 1 of the present disclosure. Upon detecting notification, by way of an earthquake warning, of an earthquake occurrence, the flood prediction system 100 predicts flooding of the flood prediction location 1002.

The wave height inputter 40 acquires a maximum wave height of the observation positions 1012 from the sensors 210 and 220 (step S101). A prediction formula of the flood depth of the flood prediction location 1002 corresponding to the observation position 1012 is acquired from the database 10 (step S102). The maximum wave height of the observation position 1012, acquired by the wave height inputter 40, is applied to the prediction formula, acquired from the database 10, to predict flood depth of the flood prediction location 1002 (step S103). The result of the prediction of flooding at the flood prediction location 1002 is displayed on the display 60 to notify the user (step S104).

As described above, in the flood prediction system according to Embodiment 1 of the present disclosure, the flood depth Dⱼₖ at the flood prediction location 1002 is predicted based on (i) the observation position 1012 selected by the prediction formula generator 20 based on the database 10, (ii) the flood depth Dⱼₖ prediction formula generated by the prediction formula generator 20 based on the database 10, and (iii) the maximum wave measurement value acquired by the wave height inputter 40 from the sensors. Thus, the flood depth Dⱼₖ at the flood prediction location 1002 on land can be accurately predicted in a short period of time. Also, since the wave height acquisition position 1011 from which the maximum wave height Hᵢₖ is acquired for use in predicting flooding is selected based on data in the database 10 which is a collection of data for each of the flood depths Dⱼₖ of the land-based areas 1001 and the maximum wave heights Hᵢₖ of the observation positions 1012 on water for multiple tsunamis, the flood depth Dⱼₖ on land can be predicted accurately based on little data.

Also, in the aforementioned description, the database 10 containing data of tsunamis to be used for processing that is located outside of the flood prediction system 100, is assumed to be used by the flood prediction system 100. However, as illustrated in FIG. 2, a database 10A may be provided inside the flood prediction system 100 and the maximum wave height Hᵢₖ of a wave at each observation positions 1012 on water and the flood depth Dⱼₖ at each land-based area 1001 that will be flooded by a wave may be stored in the database 10A.

In such a case, the flood prediction system 100 may cause the prediction formula generator 20 to refer to the information stored in the database 10A as illustrated in FIG. 2. In this flood prediction system 100, the data of the tsunami is stored in the database 10 and the flood depth Dⱼₖ regarding the tsunami is calculated. The target for prediction flooding is not limited only to tsunamis. If there is a wave that causes flooding on land that is similar to the tsunami, this flood prediction system can likewise predict the flood depth Dⱼₖ on land by storing data regarding such a wave into the database 10.

Furthermore, the prediction formula generator 20 may classify and predict the flood depth Dⱼₖ at the flood prediction location 1002 based on the severity of damage to be caused by flooding. FIG. 3B is a graph illustrating a relationship between the flood depth at the flood prediction location and the severity of damage to be caused by flooding. In FIG. 3B, the flood depth Dⱼₖ is classified into LEVEL 1, LEVEL 2, and LEVEL 3 according to the severity of damage. The levels indicate the severity of damage that is incurred. For example, LEVEL 1 means that the dwelling experiences flooding, LEVEL 2 means that the dwelling sustains damage, and LEVEL 3 means that the dwelling is swept away by the flood. The flood depth Dⱼₖ may be classified using criteria different than classification by severity of damage.

For example, as illustrated in FIG. 3B, each of the flood depths Dⱼₖ that cause damage at the flood prediction location 1002 are ranked: DD1 as warning depth 1, DD2 as warning depth 2, and DD3 as warning depth 3. With the maximum wave heights at the wave height acquisition position 1011, when the flood depth Dⱼₖ reaches the warning depths, defined as TH1 being threshold 1, TH2 being threshold 2, and TH3 being threshold 3, the prediction formula of the flood depth Dⱼₖ at the flood prediction location 1002 is expressed by formula (2).

$$[ Formula 2 ]$$

$$Flood Depth ( D ) = \{ \begin{matrix}LEVEL 1 ( exceeds DD 1 yet no more than DD 2 ) & ( TH 2 \geq H > TH 1 ) \\ LEVEL 2 ( exceeds DD 2 yet no more than DD 3 ) & ( TH 3 \geq H > TH 2 ) \\ LEVEL 3 ( exceeds DD 3 ) & ( H > TH 3 ) \end{matrix} \qquad ( 2 )$$

The thresholds TH1, TH2, and TH3 in formula (2) are set based on the maximum wave height Hᵢₖ at the wave height acquisition position 1011 for tsunamis that exceed the warning depths DD1, DD2, and DD3 stored in the database 10. A typical setting value is, for example, a minimum value among maximum wave height Hᵢₖ of tsunamis that exceed the warning depths DD1, DD2, and DD3. Also, in the aforementioned formula (2), although an example is given in which there are three warning depths DD1, DD2, and DD3, the warming depth may be of any number greater than or equal to 1.

Even in a case in which the predication formula generator 20 registers the aforementioned formula (2), the operations of the flood depth predictor 50 and the display 60 remain substantially the same. The flood depth predictor 50 refers to the storage 30 and acquires the prediction formula of flood depth Dⱼₖ stored in the storage 30. In the case in which the formula (2) is registered in the storage 30 by the prediction formula generator 20, the flood depth predictor 50 acquires the formula (2). The flood depth predictor 50 substitutes into the formula (2) the maximum wave height (maximum wave height measurement value) acquired from the wave height inputter 40 and calculates the prediction value for flood depth at the flood prediction location 1002. The display 60 displays the prediction value for flood depth at the flood prediction location 1002 that is calculated by the flood depth predictor 50. In a case in which there are multiple wave height acquisition positions 1011 set by the observation position selector 21, the flood depth predictor 50 obtains each of the flood depths Dⱼₖ using the formula (2) based on the maximum wave height Hᵢₖ acquired at each of the wave height acquisition positions 1011, and sets, as the prediction value, a value indicating the deepest depth among the obtained flood depths Dᵢₖ or the most-calculated result of the obtained flood depths Dⱼₖ.

### Modified Examples

In the above description, the prediction formula generator 20 uses, as a prediction formula, a formula where the flood depth Dⱼₖ changes linearly in relation to the maximum wave height Hᵢₖ, as illustrated in formula (1). However, the prediction formula does not have to be linear in type. For example, with the flood depth D and the maximum wave height H identified from the data in the database 10, a prediction formula in which the flood depth D changes quadratically in relation to the maximum wave height H may be generated and registered in the storage 30. Also, there is no particular restriction as to the number of wave height acquisition positions 1011 that the observation position selector 21 can select. The observation position selector 21 may set a single wave height acquisition position 1011 or may set multiple wave height acquisition positions 1011. In the case in which the observation position selector 21 sets multiple wave height acquisition positions 1011, the flood depth predictor 50 may separately calculate a prediction value using formula (1) based on the wave height acquired at each wave height acquisition position 1011 and output, as a prediction value, an average value or a maximum value of the prediction values.

### Embodiment 2

In Embodiment 1, a configuration of the flood prediction system 100 that predicts flooding at a predetermined flood prediction location 1002 is illustrated. However, taking into account, for example, that measures are taken against a tsunami and that evacuation routes are considered at the time of evacuation, it is imperative to know a distribution of flooding at not only the predetermined flood prediction location 1002 but also the surrounding land-based areas 1001. A flood prediction system 100A according to Embodiment 2 predicts flooding at the flood prediction location 1002 and also predicts a distribution of flooding in multiple blocks of land each of which contain multiple land-based areas 1001 that include the flood prediction location 1002.

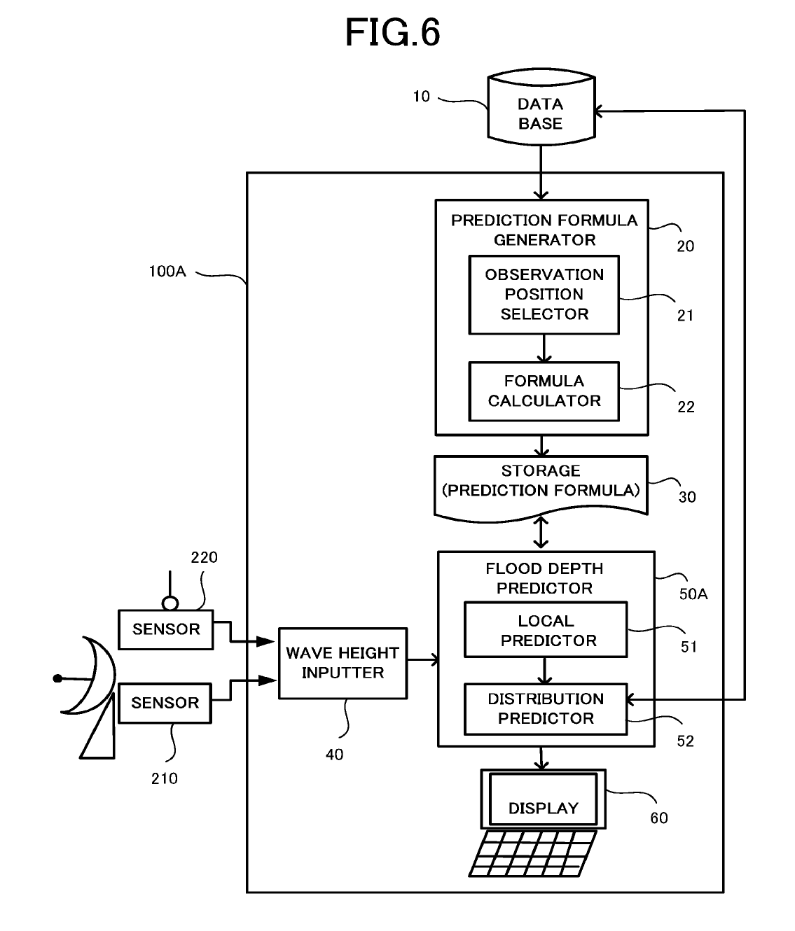

FIG. 6 is a diagram illustrating a configuration of the flood prediction system 100A according to Embodiment 2 of the present disclosure. In FIG. 6, the components of the configuration that are the same as in FIG. 2 are assigned the same reference signs, and description of such components is omitted. The flood prediction system 100A illustrated in FIG. 6 includes a flood depth predictor 50A instead of the flood depth predictor 50 in the flood prediction system 100 illustrated in FIG. 2. The flood depth predictor 50A includes a local predictor 51 and a distribution predictor 52. The database 10 and the local predictor 51 are substantially similar to the flood depth predictor 50. The distribution predictor 52 predicts a distribution of flood depths Dⱼₖ at multiple land-based areas 1001 based on a maximum wave height measurement value of the observation position 1012 input from the wave height inputter 40 and data of tsunamis stored in the database 10.

When the local predictor 51 predicts, using formula (2) stored in storage 30, that the flood depth Dⱼₖ at flood prediction location 1002 will exceed a predetermined warning depth, the distribution predictor 52 uses the data in the database 10 to calculate the prediction value of the flood depth Dⱼₖ at each of the land-based areas 1001. Specifically, the distribution predictor 52 compares (i) the maximum wave height measurement value, being the maximum wave height at the wave height acquisition position 1011, acquired by the wave height inputter 40 and (ii) the measurement value of the maximum wave heights Hᵢₖ at the wave height acquisition position 1011 for each of the tsunamis in the database 10, and obtains a corresponding tsunami. Next, the distribution predictor 52 acquires the flood depth Dᵢₖ at each of the land-based areas 1001 of the corresponding tsunami in the database 10 and recognizes the acquired values as the prediction data of the flood depth Dⱼₖ at each of the land-based areas 1001. The display 60 displays whether or not the flood depth Dⱼₖ at the flood prediction location 1002 exceeds a predetermined warning depth based on the prediction value of the local predictor 51 and the prediction data of the distribution predictor 52. In the case in which the flood depth Dⱼₖ at the flood prediction location 1002 exceeds a predetermined warning depth, the display 60 further displays a distribution of the flood depths Dⱼₖ at the land-based areas 1001 surrounding the flood prediction location 1002.

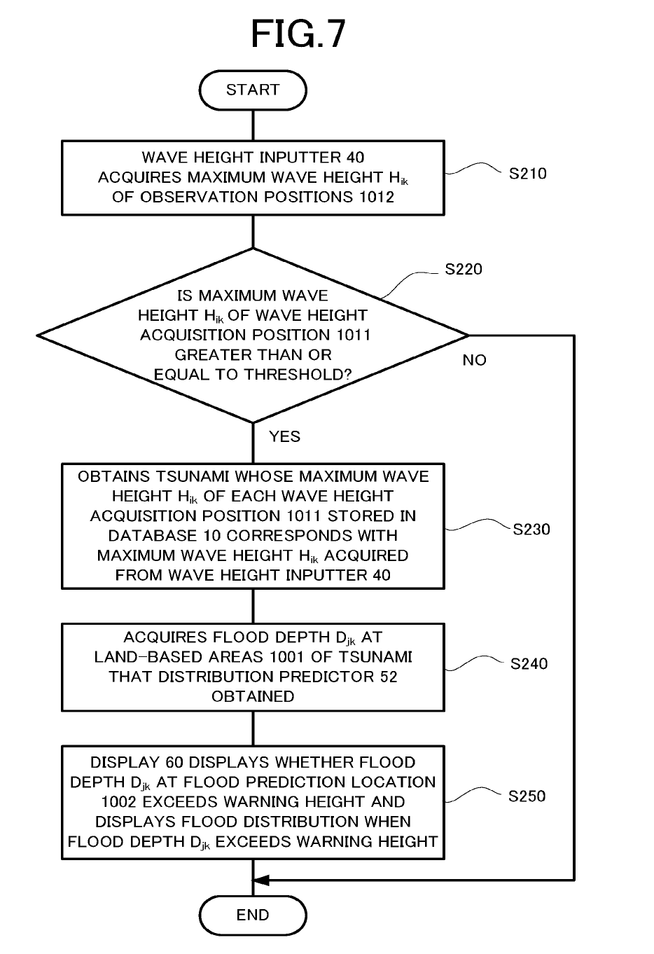

FIG. 7 is a flowchart illustrating processing for predicting flooding by the flood prediction system 100A according to Embodiment 2 of the present disclosure. The processing performed by the observation position selector 21 for selecting the wave height acquisition position 1011, the processing performed by the formula calculator 22 for generating a prediction formula for predicting flooding at the flood prediction location 1002 based on the database 10, and the processing performed by the prediction formula generator 20 for registering the wave height acquisition position 1011 and the prediction formula into the storage 30 are assumed to be completed prior to the start of this flow.

In FIG. 7, first, the wave height inputter 40 acquires the maximum wave height Hᵢₖ of each of the observations positions 1012 (step S210). Next, the local predictor 51 uses the maximum wave height Hᵢₖ of the wave height acquisition position 1011 in the observation position 1012 and the previously-described formula (2) registered in the storage 30 to predict whether or not the flood depth Dⱼₖ at the flood prediction location 1002 exceeds a predetermined warning depth. Specifically, the local predictor 51 uses formula (2) to confirm whether or not the maximum wave height Hᵢₖ of the wave height acquisition position 1011 exceeds a predetermined threshold. In a case in which the maximum wave height Hᵢₖ is less than or equal to the threshold (No in step S220), processing ends. Conversely, in a case in which the maximum wave height Hᵢₖ exceeds the threshold (YES in step S220), the distribution predictor 52 calculates a distribution of flooding at the multiple locations on land based on data in the database 10 (steps S230 to S240).

The distribution predictor 52 compares (i) the maximum wave height measurement value, being the maximum wave height at the wave height acquisition position 1011, acquired by the wave height inputter 40 and (ii) the maximum wave height Hᵢₖ at the wave height acquisition position 1011 for each of the tsunamis in the database 10, and obtains a corresponding tsunami (step S230). As a method for obtaining the corresponding tsunami, the tsunami is obtained for which there is a minimal difference between the maximum wave height measurement value for each wave height acquisition position 1011 and the maximum wave height Hᵢₖ in the database 10, and the tsunami with the most wave height acquisition positions 1011 that have a minimal difference may be recognized as the corresponding tsunami. Also, the tsunami for which the sum of squares of a difference between the maximum wave height measurement value obtained for each of the wave height acquisition positions 1011 and the maximum wave height Hᵢₖ in the database 10 is minimal may be recognized as the corresponding tsunami.

Next, the distribution predictor 52 acquires a flood depth Dⱼₖ at each land-based area 1001 of the corresponding tsunami in the database 10, and the acquired values are recognized as the prediction data of the flood depths Dⱼₖ of the land-based areas 1001 (step S240). The flood depth predictor 50A determines whether or not the flood depth Dⱼₖ at the flood prediction location 1002 exceeds a predetermined warning depth based on the prediction result of the local predictor 51 and the prediction result of the distribution predictor 52 and in the case in which the flood depth Dⱼₖ exceeds a predetermined warning depth, a flood distribution of the land-based areas 1001 surrounding the flood prediction location 1002 is displayed on the display 60 (step S250).

As described above, the flood prediction system 100A according to Embodiment 2 uses data of the database 10 and is provided with the distribution predictor 52 that calculates the flood distribution of the land-based areas 1001. Thus, in addition to having the advantages of the flood prediction system 100 according to Embodiment 1, the flood prediction system 100A can also predict a flood distribution on land.

### Embodiment 3

In the flood prediction system 100A according to Embodiment 2, flood depths Dⱼₖ at the land-based areas 1001 are obtained based on the data in the database 10. However, if the location is limited in particular to the surrounding area of the flood prediction location 1002, the flood depths Dⱼₖ at the land-based areas 1001 can also be calculated using the flood depth Dⱼₖ at the flood prediction location 1002 and terrain containing the flood prediction location 1002 and the land-based areas 1001.

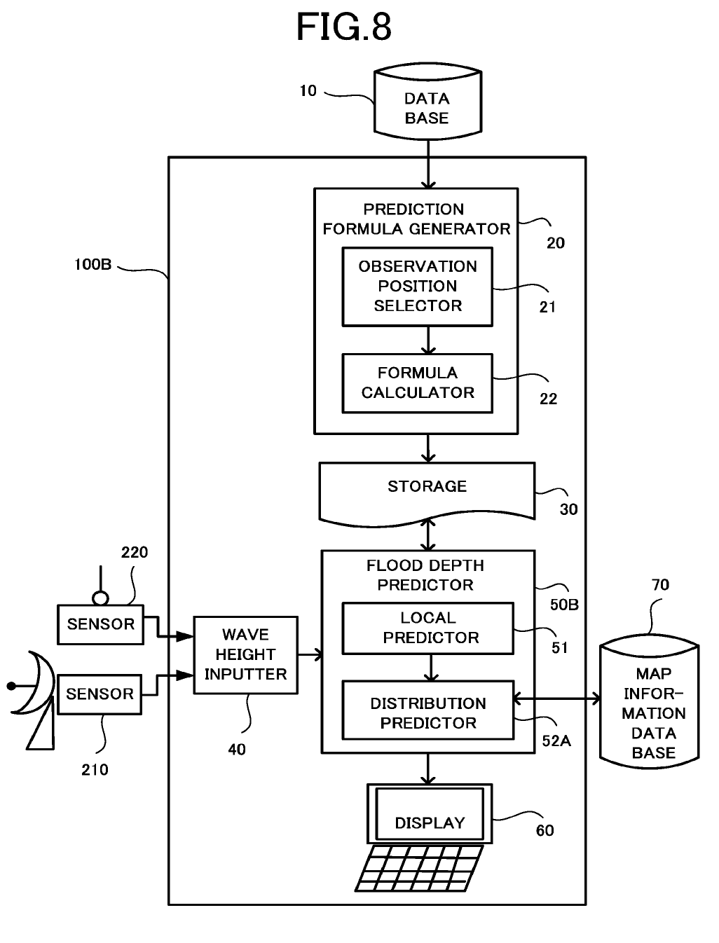

FIG. 8 is a diagram illustrating a configuration of a flood prediction system 100B according to Embodiment 3 of the present disclosure. In FIG. 8, the components of the configuration that are the same as in FIG. 2 or 6 are assigned the same reference signs, and description of such components is omitted. In FIG. 8, the flood prediction system 100B includes a flood depth predictor 50B instead of the flood depth predictor 50 of the flood prediction system 100 illustrated in FIG. 2 and instead of the flood depth predictor 50A of the flood prediction system 100A illustrated in FIG. 6. The flood depth predictor 50B includes the local predictor 51 and a distribution predictor 52A.

The distribution predictor 52A acquires elevation data of terrain of the flood prediction location 1002 and the land-based areas 1001 from a map information database 70 located outside or inside of the flood prediction system 100B. The distribution predictor 52A predicts a flood depth Dⱼₖ at each of the land-based areas 1001 based on (i) elevation difference between the flood prediction location 1002 and each of the land-based areas 1001 and (ii) the flood depth Dⱼₖ at the flood prediction location 1002 predicted by the local predictor 51.

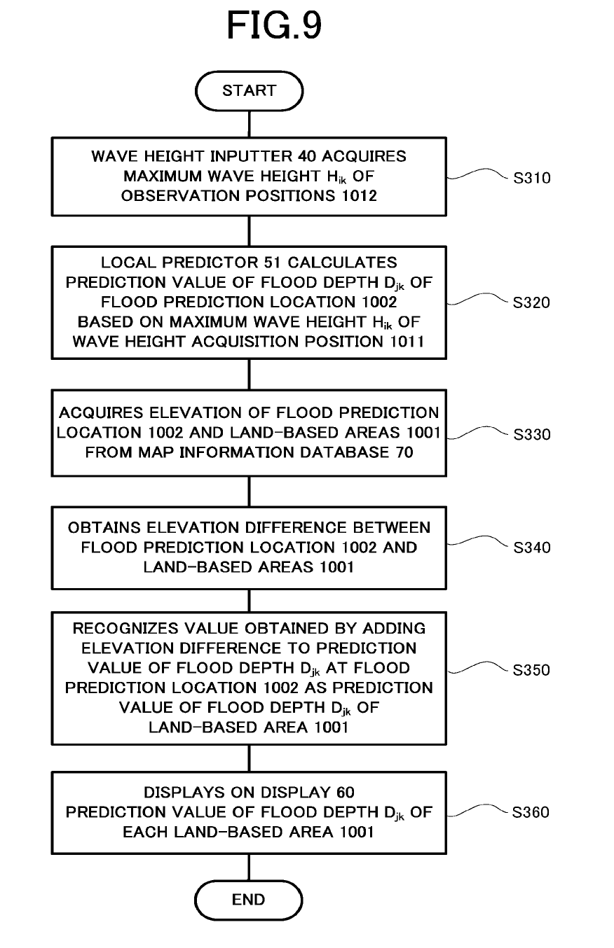

FIG. 9 is a flowchart illustrating a processing flow of a flood depth predictor of the flood prediction system 100B in Embodiment 3 of the present disclosure. The processing performed by the observation position selector 21 for selecting the wave height acquisition position 1011 and the processing performed by the prediction formula generator 20 for registering in the storage 30 a prediction formula for predicting flooding at the flood prediction location 1002 based on the database 10 for tsunamis are assumed to be completed prior to the start of this flow.

In FIG. 9, the wave height inputter 40 acquires the maximum wave height Hᵢₖ of each of the observation positions 1012 from the sensors 210 and 220 that measure wave heights on water (step S310). Next, the local predictor 51 uses (i) the maximum wave height Hᵢₖ at the wave height acquisition position 1011 selected from the observation positions 1012 and (ii) the previously-described formula (1) registered in the storage 30 to calculate the prediction value of the flood depth Dⱼₖ at the flood prediction location 1002 (step S320). The distribution predictor 52A acquires the elevation of the flood prediction location 1002 and the elevation of each of the land-based areas 1001 from the map information database 70 (step S330), and calculates a difference in elevation between the flood prediction location 1002 and each of the land-based areas 1001 (step S340). The distribution predictor 52A recognizes the value obtained by adding the elevation difference to the prediction value of the flood depth Dᵢₖ at the flood prediction location 1002 as the prediction value of the flood depth Dⱼₖ at each of the land-based areas 1001 (step S350). The display 60 displays the prediction value of the flood depth Dⱼₖ at each of the land-based areas 1001 obtained by the distribution predictor 52A (step S360).

As described above, the flood prediction system according to Embodiment 3 of the present disclosure includes the configuration of the flood prediction system according to Embodiment 1 and also includes the distribution predictor 52A that uses the predicted flood depth Dⱼₖ of the flood prediction location 1002 to forecast the flood distribution at the flood prediction location 1002 and the land-based areas 1001 based on the terrain of the flood prediction location 1002 and the terrain of the land-based areas 1001, and thus, can obtain the distribution of the flood depth Dⱼₖ of the land-based areas 1001 with a simple configuration.

### Embodiment 4

In the flood prediction system 100A according to Embodiment 2, the distribution predictor 52 predicts the flood depth Dᵢₖ of the land-based areas 1001 based on the data in the database 10. In the procedure for the distribution predictor 52, a value of the flood depth Dⱼₖ from data of an observed tsunami or simulated data of simulated tsunamis is used. Therefore, although the relationship between the land-based areas 1001 regarding the flood depth Dⱼₖ is accurate, the accuracy of the value of the flood depth Dⱼₖ of each of the land-based areas 1001 is limited by, for example, the amount of data that can be collected in the database 10. In contrast, in the local predictor 51, an accurate flood depth Dⱼₖ can be obtained by using a prediction formula. Therefore, a flood prediction system 100C can be obtained that can accurately calculate a distribution of flooding in the land-based areas 1001 by correcting the flood depth Dⱼₖ of the land-based areas 1001 obtained by the distribution predictor 52 with the flood depth Dⱼₖ calculated by the local predictor 51.

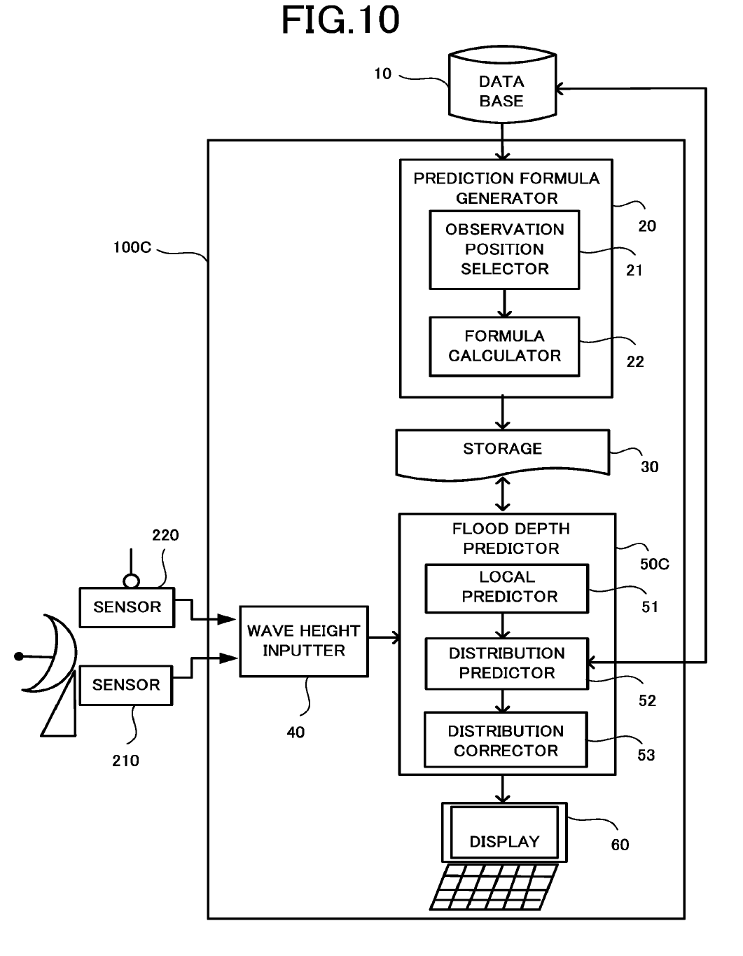

FIG. 10 is a diagram illustrating a configuration of the flood prediction system 100C according to Embodiment 4 of the present disclosure. In FIG. 10, the components of the configuration that are the same as in FIG. 2, 6, or 8 are assigned the same reference signs, and description of such components is omitted. In FIG. 10, the flood prediction system 100C includes a flood depth predictor 50C instead of the flood depth predictor 50A of the flood prediction system 100A illustrated in FIG. 6. In addition to including the local predictor 51 and the distribution predictor 52 of flood depth predictor 50A, the flood depth predictor 50C also includes a distribution corrector 53.

Similar to that in the flood depth predictor 50A, in the flood depth predictor 50C, the local predictor 51 calculates the flood depth Dⱼₖ at the flood prediction location 1002 based on the maximum wave height Hᵢₖ at the wave height acquisition position 1011 acquired from the wave height inputter 40, the wave height acquisition position 1011 stored in the storage 30, and a prediction formula. Similar to that in the flood depth predictor 50A, in the flood depth predictor 50C, the distribution predictor 52 uses the value of the maximum wave height Hᵢₖ at the wave acquisition positions 1011 and the tsunami data stored in the database 10 to calculate a distribution of flooding at the land-based areas 1001. The distribution corrector 53 corrects the flood distribution calculated by the distribution predictor 52 based on the prediction value of the flood depth Dⱼₖ at the flood prediction location 1002 that is calculated by the local predictor 51. More specifically, the distribution corrector 53 recognizes the difference between (i) the prediction value of the flood depth Dⱼₖ of the flood prediction location 1002 calculated by the local predictor 51 and (ii) the prediction value of the flood depth Dⱼₖ at the same flood prediction location 1002 predicted by the distribution predictor 52 based on the maximum wave height Hᵢₖ at the observation position and the database 10, as the correction value, and uses the correction value to correct the flood depth Dⱼₖ at the land-based areas 1001 that is calculated by the distribution predictor 52. The display 60 displays the corrected flood distribution that is outputted by the distribution corrector 53.

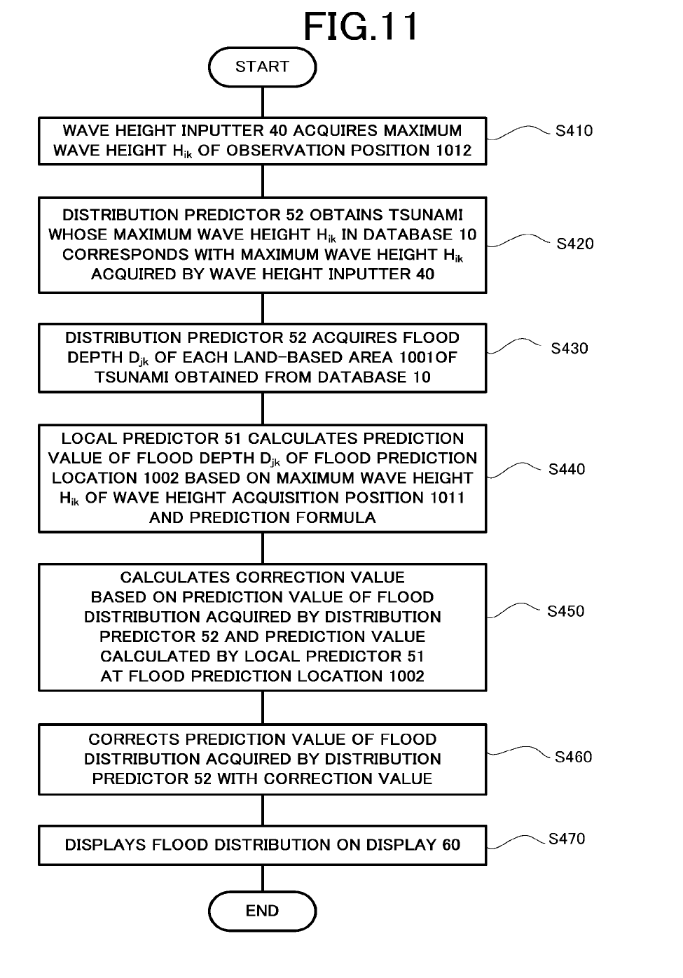

FIG. 11 is a flowchart illustrating a processing flow of the flood depth predictor of the flood prediction system 100C according to Embodiment 4 of the present disclosure. The processing by the observation position selector 21 for selecting the wave height acquisition position 1011 and the processing by the prediction formula generator 20 for registering in the storage 30 a prediction formula for predicting flooding at the flood prediction location 1002 based on the tsunami database 10 are assumed to be completed prior to the start of this flow.

In FIG. 11, the wave height inputter 40 acquires the maximum wave height Hᵢₖ of each wave height acquisition position 1011 from the sensors 210 and 220 (step S410). Next, the distribution predictor 52 obtains, from the tsunami data stored in the database 10, a tsunami whose maximum wave height Hᵢₖ in the database 10 corresponds with the value (maximum wave height measurement value) of the maximum wave height Hᵢₖ at each wave height acquisition position 1011 acquired by the wave height inputter 40 (step S420). As a method for obtaining the corresponding tsunami, for example, the tsunami for which there is a minimal difference between the maximum wave height measurement value for each wave height acquisition position 1011 and the maximum wave height Hᵢₖ in the database 10, and the tsunami with the most wave height acquisition positions 1011 that have a minimal difference is recognized as the corresponding tsunami. Also, for example, a tsunami for which the sum of squares of a difference between the maximum wave height measurement value obtained for each of the wave height acquisition positions 1011 and the maximum wave height Hᵢₖ in the database 10 is minimal may be recognized as the corresponding tsunami. The distribution predictor 52 acquires the flood depth Dⱼₖ at each land-based area 1001 of the tsunami obtained from the database 10 and recognizes the flood depths Dⱼₖ as the prediction values of the flood distribution at each of the land-based areas 1001 (step S430).

The local predictor 51 uses the maximum wave height Hᵢₖ at the maximum wave height acquisition position 1011 among the observation position 1012 and the previous-described formula (1) registered in the storage 30 to calculate the prediction value of the flood depth Dⱼₖ at the flood prediction location 1002 (step S440). The processing of step S440 may be performed before the processing of steps S420 to S430 or the other way around. Alternatively, the processing of steps S420 to S430 may be performed while the proceeding of step S440 is being performed.

The distribution corrector 53 calculates the difference between the prediction value of the flood distribution acquired by the distribution predictor 52 and the prediction value of the flood depth Dⱼₖ calculated by the local predictor 51, which are taken at the flood prediction location 1002, and recognizes this difference as the correction value (step S450). The distribution corrector 53 uses the correction value to correct the flood depths Dⱼₖ at the land-based areas 1001 that are calculated by the distribution predictor 52 (step S460). The flood depth predictor 50C displays the flood distribution on the display 60 based on the flood depths Dⱼₖ of each flood prediction location 1002 that are corrected by the distribution corrector 53 (step S470).

As described above, in the flood prediction system according to Embodiment 4, a correction value is calculated based on the difference between the prediction value of the flood distribution acquired by the distribution predictor 52 and the prediction value of the flood depth Dⱼₖ calculated by the local predictor 51 and the prediction value of the flood distribution acquired by the distribution predictor 52 is corrected using the correction value. Therefore, the flood prediction system according to Embodiment 4, in addition to having the advantages of the flood prediction systems in Embodiments 1 and 2, is advantageously capable of accurately obtaining a flood distribution of a wide area.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2016-190508 filed on Sep. 29, 2016, the entire disclosure of which is incorporated by reference herein.

### INDUSTRIAL APPLICABILITY

The present disclosure is suitably applicable to flood prediction systems that predict flooding on land caused by a tsunami.

### REFERENCE SIGNS LIST

10, 10A Database
20 Prediction formula generator
21 Observation position selector
22 Formula calculator
30 Storage
40 Wave height inputter
50, 50A, 50B, 50C Flood depth predictor
51 Local predictor
52, 52A Distribution predictor
53 Distribution corrector
60 Display
70 Map information database
100, 100A, 100B, 100C Flood prediction system
210, 220 Sensor
300 Internal bus
307 Control program
1000, 1010 Collection
1001 Land-based area
1002 Flood prediction location
1011 Wave height acquisition position
1012 Observation position
1020 Coastline
1021 Sea
1022 Land
1030 Arrow

1. A flood prediction system for predicting flood depths of flood prediction locations on land that will be flooded due to a tsunami, the flood prediction system comprising:
a prediction formula generator to select, based on (i) data of a maximum wave height at each of a plurality of observation positions on water and (ii) data of a flood depth in a land-based area containing the flood prediction locations for each of a plurality of tsunamis stored in a database, at least one of the observation positions as a wave height acquisition position in order to predict a flood depth of a flood prediction location and to generate a prediction formula for predicting the flood depth of the flood prediction location based on a maximum wave height in the maximum wave height acquisition position; and
a flood depth predictor to acquire a maximum wave height measurement value of the wave height acquisition position and to predict the flood depth of the flood prediction location by using the acquired maximum wave height measurement value and the prediction formula.

2. The flood prediction system according to claim 1, wherein the prediction formula generator selects the observation position with a correlative relationship between the data of the maximum wave height at the observation position and the data of the flood depth in the land-based area containing the flood prediction location, in order to predict the flood depth of the flood prediction location.

3. The flood prediction system according to claim 1, wherein the prediction formula generator selects the wave height acquisition position based on a distance between the flood prediction location and the observation position.

4. The flood prediction system according to claim 1, wherein the prediction formula generator generates the prediction formula in which a flood depth of the flood prediction location monotonically increases as a maximum wave height of the wave height acquisition position increases.

5. The flood prediction system according to claim 1, wherein the flood depth predictor predicts whether or not a flood depth of the flood prediction location is within one of a plurality of predetermined numerical ranges.

6. The flood prediction system according to claim 1, further comprising the database.

7. The flood prediction system according to claim 1, wherein
the flood prediction location is one of a plurality of flood prediction locations, and, within the database, data of the flood depth in each of the land-based areas containing the flood prediction locations of each of the tsunamis is stored,
the prediction formula generator selects as the wave height acquisition position at least one of the observation positions for each of the flood prediction locations based on the data of the maximum wave height and the data of the flood depth that are stored in the database and generates a prediction formula for predicting a flood depth of the flood prediction locations based on the maximum wave height in the wave height acquisition position,
the flood depth predictor acquires the maximum wave height measurement value of the wave height acquisition position and predicts the flood depth of the flood prediction locations by using the maximum wave height measurement value and the prediction formula that is for predicting the flood depth of the flood prediction locations.

8. The flood prediction system according to claim 1, wherein the flood depth predictor refers to a map information database in which elevation data is stored, uses (i) an elevation difference that is a difference between elevation data of each land-based area that will be flooded due to a tsunami and the elevation data of the flood prediction location and (ii) the predicted flood depth of the flood prediction location, and predicts a flood depth of the flood prediction location and the land-based areas.

9. The flood prediction system according to claim 1, wherein
data of the flood depth of each of a plurality of the land-based areas that will be flooded due to the tsunami for each of the plurality of tsunamis is stored in the database,
and further comprising a distribution predictor that predicts a flood depth of the land-based areas based on (i) data of the maximum wave height in the wave height acquisition position and (ii) data of the flood depth in each of the land-based areas stored in the database, and (iii) the maximum wave height measurement value in the wave height acquisition position.

10. The flood prediction system according to claim 9, further comprising a distribution corrector that calculates, as a correction value, a difference between (i) a flood depth of the flood prediction location predicted by using the prediction formula and (ii) a flood depth of the land-based area containing the flood prediction location predicted by the distribution predictor and uses the correction value to correct the flood depth in each of the land-based areas predicted by the distribution predictor.

11. The flood prediction system according to, claim 9, wherein in a case in which a flood depth of the flood prediction location exceeds a predetermined threshold, the distribution predictor predicts a flood depth of the land-based areas.

12. A prediction method for predicting flood depths of flood prediction locations on land that will be flooded due to a tsunami, the prediction method comprising:
selecting, based on (i) data of a maximum wave height at each of a plurality of observation positions on water and (ii) data of a flood depth in a land-based area containing the flood prediction locations for each of a plurality of tsunamis stored in a database, at least one of the observation positions as a wave height acquisition position in order to predict a flood depth of a flood prediction location
generating a prediction formula for predicting the flood depth of the flood prediction location based on a maximum wave height in the wave height acquisition position, and
acquiring a maximum wave height measurement value the wave height acquisition position and predicting a flood depth of the flood prediction location by using the acquired maximum wave height measurement value and the prediction formula.

13. A non-transitory computer-readable recording medium storing a program for causing a computer to perform a series of processing for predicting flood depths of flood prediction locations on land that will be flooded due to a tsunami, the series of processing comprising:
selecting, based on (i) data of a maximum wave height at each of a plurality of observation positions on water and (ii) data of a flood depth in a land-based area containing the flood prediction locations for each of a plurality of tsunamis stored in a database, at least one of the observation positions as a wave height acquisition position in order to predict a flood depth of a flood prediction location,
generating a prediction formula for predicting the flood depth of the flood prediction location based on a maximum wave height in the wave height acquisition position, and
acquiring a maximum wave height measurement value at the wave height acquisition position and predicting a flood depth of the flood prediction location by using the acquired maximum wave height measurement value and the prediction formula.
